(19) United States
(12) Patent Application Publication
(10) Pub. No.: US 2016/0185902 A1
(43) Pub. Date: Jun. 30, 2016

(54) CONTINUOUS REACTION DEVICE FOR SYNTHESIZING POLYOXYMETHYLENE DIMETHYL ETHERS

(71) Applicants: Dongfang Hongsheng New Energy Application Technology Research Institute Co., Ltd, Beijing (CN); China University Of Petroleum (Eastern China), Tsingdao (CN)

(72) Inventors: Hongyan SHANG, Tsingdao (CN); Zhengpeng HONG, Beijing (CN); Chengyue LI, Beijing (CN); Xiaoting FENG, Chengdu (CN); Yu HAN, Beijing (CN); Zhenzhen XUE, Tsingdao (CN)

(73) Assignees: Dongfang Hongsheng New Energy Application Technology Research Institute Co., Ltd, Beijing (CN); China University Of Petroleum (Eastern China), Tsingdao (CN)

(21) Appl. No.: 14/980,598

(22) Filed: Dec. 28, 2015

(30) Foreign Application Priority Data
Dec. 26, 2014 (CN) 201410831935.4

(51) Int. Cl. C08G 65/00; B01J 8/08; B01J 8/10

(52) U.S. Cl. CPC C08G 65/00; B01J 8/10; B01J 8/082; B01J 8/087; B01J 2208/00212; B01J 2208/00548; B01J 2208/00867

(57) ABSTRACT

The present invention pertains to the technical field of energy resource chemical industry, and in particular relates to a continuous reaction device and process for synthesizing polyoxymethylene dimethyl ethers by using paraformaldehyde and methylal as feedstock or using trioxane and methylal as feedstock in the presence of an acidic catalyst. The continuous reaction device comprises multiple slurry bed stirred tank reactors connected in series or in combination of series connection and parallel connection, and also comprises an on-line solid-liquid separation device to perform separation of the reaction mixture from the catalyst. Each of the tank reactors is provided with an axial-flow stirring paddle having 2-6 blades per layer, to ensure sufficient mixing of the reactants with the catalyst. By using a distributed control pattern of reaction temperature and feedstock supplying to enhance the process and to optimize the operation, the reaction device of the present invention can effectively achieve large-scale continuous production of polyoxymethylene dimethyl ethers, and both the yield rates and the distribution of the reaction product are better than those of prior art.

### TECHNICAL FIELD

The present invention pertains to the technical field of energy resource chemical industry, and in particular relates to a continuous reaction device for synthesizing polyoxymethylene dimethyl ethers.

### BACKGROUND OF THE INVENTION

In recent years, phenomenon of short supply of diesel fuel frequently occurred in China, and its fundamental reason is the restriction of resource shortage. Traditionally, diesel fuel production relies upon petroleum feedstock, and the resource endowment of China characterized in relatively “rich in coal, poor in oil, and lack in gas” leads to increasingly prominent contradiction between petroleum supply and relatively fast sustaining development of economics and society. Since the year 1993 when China became a net importer of petroleum, the import volume has been increasing fast and constantly, and the foreign-trade dependence already surpassed 56% after 2011, which has a severe influence on national strategic security of energy.

Furthermore, the worsening of crude oil quality leads to continuous scale expansion of domestic catalytic processing of heavy oil and increasing percentage of diesel fuel produced by catalytic processing, which results in gradual decrease of the cetane number (CN value) of diesel fuel products and significant increase of noxious substance discharged after combustion, therefore, the urgent problem to be solved is to increase the CN value of diesel fuel.

The tail gas discharged by a diesel engine contains a large amount of noxious substance such as unburned hydrocarbon compounds and particulate matter (PM), as well as CO, CO₂ and NOₓ, which are one of the main sources of PM2.5 contamination in urban air. International Agency for Research on Cancer (IARC) affiliated to World Health Organization (WHO) declared in June, 2012 the decision to elevate the cancer hazard ranking of diesel engine tail gas, from “possibly carcinogenic” classified in 1988 to “definitely carcinogenic”. As scientific research advances, now there is enough evidence to prove that diesel engine tail gas is one of the reasons that cause people to suffer from lung cancer. Furthermore, there is also limited evidence indicating that, inhaling diesel engine tail gas is relevant to suffering from bladder cancer. IARC hopes that this reclassification can provide reference for national governments and other decision makers, so as to actuate them to establish more strict discharge standards of diesel engine tail gas. Under this background, many international institutes are carrying out R&D on production technologies of oxygen-containing blending components for petrol and diesel fuel, especially those diesel fuel blending components with high oxygen contents and high cetane numbers, and this has recently become a research hotspot in the technical field of new energy.

Polyoxymethylene dimethyl ethers (also named as poly-methoxymethylal or polyformal-dimethyl-ethers, with a general formula of CH₃(OCH₂)ₙOCH₃ and abbreviated as DMMₙ, n=2-8), which is a yellow liquid with a high boiling point, an average cetane number reaching above 76 and increasing dramatically as its polymerization degree increases, an average oxygen content of 47%-50%, a flash point of about 65.5° C., and a boiling point of about 160-280° C., is a type of clean diesel fuel blending component with a high cetane number. When polyoxymethylene dimethyl ethers are blended into ordinary diesel fuel according to a certain ratio (e.g., 15% by volume), they can significantly increase oxygen content of the diesel fuel product, facilitate sufficient combustion of diesel fuel and greatly reduce discharge of combustion contaminants, without the need to modify the engine oil feeding system. Furthermore, as polyoxymethylene dimethyl ethers added into diesel fuel cause dilution of the ordinary diesel fuel, accordingly, the contents of aromatic compounds and sulfides in the diesel fuel product are reduced.

Synthesis of polyoxymethylene dimethyl ethers may be carried out by processing synthesis gas through a series of steps of methanol, formaldehyde, methylal and polyformaldehyde etc. Producing methanol from coal, natural gas and coke-oven gas are mature techniques. Developing technological advanced and economical reasonable industrial technology of synthesizing polyoxymethylene dimethyl ethers from methanol as upstream feedstock can not only provide a new technology to significantly increase diesel fuel product quality, but also improve the feedstock structure of diesel fuel production by making it more suitable for the resource endowment of domestic fossil energy and the realistic structure of primary energy production, thereby greatly increase supply capability of quality diesel fuel product.

In the aspect of synthesis of polyoxymethylene dimethyl ethers, a lot of domestic and abroad work has been done regarding research and development of methods for synthesizing polyoxymethylene dimethyl ether products where n=2-10 by using methanol, methylal, low-carbon alcohol, formaldehyde aqueous solution, paraformaldehyde, etc. as feedstock in the presence of an acidic catalyst.

In various kinds of feedstock route, more research has been done on the synthesis of polyoxymethylene dimethyl ethers from paraformaldehyde and methylal as feedstock or from trioxane and methylal as feedstock. For example:

U.S. Pat. No. 2,449,469A disclosed a method for producing polyoxymethylene dialkyl ethers, which includes producing polyoxymethylene dimethyl ethers at 80-100° C., aided by function of an acidic catalyst, in a stirred tank reactor using batch operation.

U.S. Pat. No. 5,746,785A disclosed a method for synthesizing polyoxymethylene dialkyl ethers from methylal and paraformaldehyde as feedstock, aided by function of a small amount of formic acid, in a tank reactor using batch operation.

U.S. Patent Application US2007/0260094A1 disclosed a method for producing polyoxymethylene dimethyl ether from methylal and trioxane as feedstock in the presence of an acidic catalyst. In this method, the water content in the reaction mixture of methylal, trioxane and acidic catalyst should not exceed 1%. Polyoxymethylene dimethyl ethers of n=3 and n=4 in the reaction product are separated by rectification, while methylal, trioxane, polyoxymethylene dimethyl ethers with polymerization degree of n<3, and part of polyoxymethylene dimethyl ethers with polymerization degree of n>4 are recycled.

Chinese Patent Application CN101048357A by BASF disclosed a method for catalytically synthesizing polyoxymethylene dimethyl ethers with methoxy group polymerization degree of 2-10 from methylal and trioxane as feedstock, in the presence of a homogeneous or heterogeneous acidic catalyst such as liquid mineral acid, sulfonic acid, heteropolyacid, acidic ion-exchange resin, zeolite, etc. at a pressure of 1-20 bar and a reaction temperature of 50° C.-200° C., with strictly limiting the water content introduced into the system. By optimization, polyoxymethylene dimethyl ethers with methoxy group polymerization degree of 3 and 4 can be separated by distillation through three towers.

The reaction of catalytically synthesizing a series of polyoxymethylene dimethyl ether target products with polymerization degree of n=2-8 from paraformaldehyde and methylal as feedstock or from trioxane and methylal as feedstock in the presence of an acidic catalyst under related operation conditions (the main reaction) is a group of reversible exothermic reactions with a stoichiometry equation as follows:

CH₃O(CH₂O)ₙ₋₁CH₃+HCHO<=>CH₃O(CH2O)ₙCH₃+Qₙ₋₁

Wherein, n denotes methoxy group polymerization degree, n≧2; Q₁ denotes heat release of the i^{th} main reaction, i=n−1; the formaldehyde (HCHO) comes form depolymerization of polyformaldehyde feedstock.

Besides the main reaction sequences in series (i.e. the polymerization degree decreasing or increasing) and in parallel (i.e. formaldehyde taking part in polycondensation of target products with different polymerization degrees at the same time), there also exists a series of side reactions in the reaction system. For example, when the feedstock contains water, there also exists a reaction of methylal (DMM) hydrolyzing into hemiacetal and methanol, as well as a reaction of methanol dehydrating into dimethyl ether, and etc., thereby constituting a complicated reaction network.

Therefore, in recent years, abroad, Jakob Burger etc. [Fuel 89(2010) 3315-3319] researched synthesis of DMMₙ by using methylal and trioxane as feedstock and using ion-exchange resin as a catalyst in a laboratory stirred tank reactor with batch operation, and focused on studying the relationship between reaction equilibrium composition and reaction temperature as well as feedstock mass ratio. Domestically, research institutes such as Lanzhou Institute of Chemical Physics affiliated to Chinese Academy of Sciences and higher education universities such as Nanjing University, Lanzhou University of Science and Technology East China University of Science and Technology etc. have been doing basic and applied research as well as reaction technology development in aspects of catalyst screening, reaction process and chemical thermodynamics with respect to synthesis of DMMₙ.

Chinese Patent Application CN102249869A disclosed a process for synthesizing polyoxymethylene dimethyl ethers by using trioxane together with methanol or methylal as feedstock and using acidic ionic liquid as a catalyst. Wherein, a single-stage or multi-stage tubular reactor with external circulating heat exchange is used. However, as calculated according to data provided by its embodiments, a mean detention time of reaction mass in the reaction system is of the order of hours. Except for mixing by circulating, there is no other description of how to ensure sufficient mixing and dispersion of the liquid heterogeneous system in the reaction tubes.

Chinese Patent Application CN102432441A disclosed a process for synthesizing polyoxymethylene dimethyl ethers by using methylal and trioxane as feedstock and using cation exchange resin as a catalyst in a fixed bed reactor, under the condition of an reaction temperature of 80° C.-150° C., a pressure of 0.6 MPa-4.0 MPa and nitrogen atmosphere, which mainly produced polyoxymethylene dimethyl ether products of n=3 and n=4.

Chinese Patent Application CN102701923A disclosed a system device and a process for producing polyoxymethylene dimethyl ethers. A shell-and-tube reactor comprising eight segments connected in series with inner static mixing elements is used for a liquid-liquid catalytic reaction system for synthesizing polyoxymethylene dimethyl ethers by using trioxane and methylal as feedstock and using ionic liquid as a catalyst. Its main characteristic is a simple structure, a larger heat exchange area per unit volume of the reactor, etc. However, as calculated according to data provided by its embodiments, the total cross-section linear speed in the reaction tube appears to be very low, and there is no description of whether the two phases can be mixed sufficiently or whether the dispersion phase can be dispersed sufficiently. Furthermore, although the main reaction is a series of reversible exothermic reactions, because of the restriction of reaction kinetics, with a limited heat release rate per unit effective reactor volume during a unit period of time, it remains a question whether a very large specific area for heat exchange is required.

Chinese Patent Application CN103360224A disclosed a technical solution to make the reaction equilibrium to move towards a direction that is beneficial for producing the target product by means of synthesis in a stirred tank reactor and subsequent dehydration in a membrane separation apparatus, and the dehydration product is recycled to the reactor until complete reaction of formaldehyde in the reaction-separation coupling device. Apparently, the stirred tank reactor/membrane separation apparatus as a whole is still using batch operation, which adversely affects the process intensity and is disadvantageous for large-scale implementation of a single series of equipments.

To sum up, there have already been lots of researches about producing the target product DMMₙ by using paraformaldehyde and methylal as feedstock or using trioxane and methylal as feedstock, with catalysts covering almost all important types of acidic catalysts. However, it is found out during implementation that, the experiments carried out by using paraformaldehyde and methylal as feedstock or using trioxane and methylal as feedstock in the presence of all kinds of acidic catalysts under pressurized condition all involve a system of slow solid-solid-liquid, solid-liquid or liquid-liquid complicated heterogeneous catalytic reaction, which leads to that the chemical reaction rate is always very low in the general processes and that the reaction is generally required to last for hours or even longer. Therefore, the R&D of a suitable reaction device has become one of the key factors limiting large-scale industrialization of this technology.

### SUMMARY OF THE INVENTION

Therefore, the key technical problem to be solved by the present invention is to provide a reaction device configuration and an optimized operation mode suitable for large-scale industrialization, based on thermodynamic characteristics, kinetic characteristics and related phase characteristics of the reaction mixture, thereby increasing macroscopic chemical reaction rate, once-through yield of the target products and selectivities of substances with higher methoxy group polymerization degrees in the series of target products.

The present invention provides a continuous reaction device for synthesizing polyoxymethylene dimethyl ethers, the reaction using paraformaldehyde and methylal as feedstock or using trioxane and methylal as feedstock and being carried out in the presence of an acidic catalyst, wherein,

the continuous reaction device comprises multiple stirred tank reactors connected in series or in combination of series connection and parallel connection, and also comprises an on-line solid-liquid separation device to perform solid-liquid separation of the reaction mixture from the catalyst;
each of the tank reactors is independently controlled at a pressure of 1.0-4.0 MPa and a temperature of 50-120° C.; a molar ratio of paraformaldehyde or trioxane, metered in mole number of formaldehyde contained therein, to methylal in the feedstock is 0.5-5.0; and the amount of the catalyst is equal to 1.0-4.0 wt % of the total amount of the feedstock;
each of the tank reactors is provided with an axial-flow stirring paddle having 2-6 blades per layer, to ensure sufficient mixing of the reaction mixture and catalyst.

Preferably, in each of the tank reactors, the highest operation pressure is 1.0-3.0 MPa, the highest operation temperature is 110° C., and the molar ratio of paraformaldehyde or trioxane, metered in mole number of formaldehyde contained therein, to methylal in the feedstock is 1.5-4.0.

The acidic catalyst is preferably strong acidic cation exchange resin commonly used in prior art.

Preferably, when paraformaldehyde powder and methylal are used as feedstock for the synthesis reaction, the on-line solid-liquid separation device is arranged after the last one of the reactors, to perform the separation of the reaction mixture from the catalyst slurry; and a recycling pipeline is provided to recycle the catalyst, obtained after sufficient solid-liquid separation and blended with a part of the methylal feedstock, into the first one of the reactors, so that continuous and steady operation of the reaction device is achieved.

Preferably, when sufficiently pre-depolymerized paraformaldehyde and methylal are used as feedstock or trioxane and methylal are used as feedstock, each of the reactors is provided with an on-line solid-liquid separation device arranged at the inside or outside thereof to perform the separation of the reaction mixture from the catalyst.

Furthermore, the on-line solid-liquid separation device arranged at the inside of each of the reactors is composed of powder metallurgy filtering elements which is divided into two groups, with one group for filtering and the other group for purging, and with alternation switching, so that the catalyst is retained within the reactor.

Furthermore, the on-line solid-liquid separation device arranged at the outside of each of the reactors is a multitubular filter performing on-line cross-flow filtering, with reaction mixture/catalyst slurry effluent from each of the reactors flowing top-to-bottom inside the tubes of the multitubular filter, so that the concentrated catalyst slurry is recycled back into the same one of the reactors and the filtrate is transported into the next one of the reactors as a feed stream.

A difference in operation pressure between two adjacent ones of the tank reactors is utilized as a driving force of filtering, to achieve solid-liquid filtering separation as well as transport of the reaction mixture from one reactor to the next.

Each of the reactors is provided with a jacket or coiled half-pipe arranged outside a barrel of the each reactor for serving as a heater when starting operation as well as a cooler during normal operation; and each of the reactors is provided with an internal heat exchanger arranged at the inside thereof for serving as a cooler during normal operation.

An interlock control system is provided at the bottom of each of the reactors for controlling the initial fluidization of the catalyst and the starting of the stirring paddle, to ensure operation safety when the added amount of the catalyst is relatively large.

The reaction device includes 2-8 slurry bed stirred tank reactors, and preferably 4-7 reactors.

The operation temperature of the reactors decreases successively by 5-20° C. per reactor; or the entire reaction is controlled by controlling of the feedstock feeding pattern of the reaction device, either by feeding all the feedstock at the first one of the reactors, or by distributed feedstock feeding, i.e. most of the feedstock is fed at the first one of the reactors of the reaction device, and the remaining feedstock is fed at each of the subsequent reactors according to certain ratios.

The reaction device of the present invention uses a reactor configuration composed of 2-8 continuously operated slurry bed stirred tank reactors connected in series or in combination of series connection and parallel connection. The continuous operation mode is undoubtedly beneficial for large-scale industrialization, and this kind of reactor configuration artificially divides the reaction device into several reaction sub-regions (i.e. each being a single slurry bed stirred tank reactor) along a longitudinal direction (i.e. a process flow direction from feedstock entry to product mixture outflow), with the heterogeneous system in each reaction sub-region able to mix sufficiently, and also with the residence time distribution of the entire reactor combination able to approach a plug flow pattern, which is beneficial for reducing the total effective volume required for the entire reaction device as far as possible, thereby reducing primary investment.

The reaction device of the present invention designs suitable technical solutions for on-line solid-liquid separation of reaction mixture/catalyst accordingly based on feedstock types and phases as well as specific characteristics of phase change during the entire reaction process. For example, when paraformaldehyde powder and methylal are used as feedstock, the on-line solid-liquid separation of reaction mixture/catalyst is performed after the reaction mixture is completed converted into liquid phase, and the catalyst obtained by separation goes through a methylal/catalyst slurry preparation step and is then recycled into the first one of the reactors. When sufficiently pre-depolymerized paraformaldehyde or trioxane together with methylal are used as feedstock, each reactor is provided with a special purpose on-line cross-flow filtering unit arranged at the outside or inside thereof to separate the reaction mixture/catalyst into two streams, i.e. a filtrate stream and a concentrated slurry stream containing solid catalyst, and a difference in operation pressure between two adjacent reactors is utilized to transport the filtrate into the next reactor as a feed stream, while a pump is used to recycle the concentrated slurry containing solid catalyst into the same reactor.

Meanwhile, the reaction device of the present invention also does optimized design on each single slurry bed stirred tank reactor as a fundamental function unit of the entire reaction device. In order to intensify the catalytic reaction process and at the same time save energy, in consideration of chemical physical characteristics of the system, each stirred tank reactor is provided with a multi-layer axial-flow stirring paddle having 2-6 blades per layer, thereby ensuring the reaction system reaches highest mixing efficiency and controlling the solid-solid-liquid or solid-liquid system composed of the reaction mixture and catalyst at a “completely mixed evenly” condition. At the same time, the installed power and rotate speed of the stirring paddle can be adjusted according to the variation tendency of catalytic reaction rate along the route, thereby reducing the total energy consumption of the stirring mixing process as far as possible.

The reaction device of the present invention may use various possible control modes of reaction temperature. Besides isothermal operation with each reactor at the same temperature, a distributed control mode of operation conditions may also be used. As indicated by theoretical calculation, within a reasonable temperature range of the reaction, the equilibrium constant of the target product synthesis reaction is very sensitive to temperature change and its sensitivity increases as the methoxy group polymerization degree increases in the products. Based on the aforementioned knowledge of thermodynamic characteristics of the reaction system, the present invention utilizes an optimized spatial distribution of reaction temperature for the continuously operated multiple slurry bed stirred tank reactors connected in series under the condition of basically eliminating the influence of diffusion and at proper temperatures and pressures. For example, the reaction temperature is controlled to decrease successively per reactor in a stepwise manner so as to repeatedly and duly break through the constraints of chemical reaction thermodynamic equilibrium, thereby increasing average chemical reaction rate, once-through conversion rate of feedstock and once-through total yield rate of target products, as well as improving selectivity of target products with suitable methoxy group polymerization degrees to intensify the reaction process.

The reaction device of the present invention may also use various possible feedstock feeding patterns. Besides the pattern of feeding all the feedstock at the first reactor, a distributed feedstock feeding pattern may also be used. According to the aforementioned structure characteristics of the reaction network composed of main reactions and side reactions, for the continuously operated multiple slurry bed stirred tank reactors connected in series, in order to inhibit hydrolysis side reactions which consume part of the methylal due to localized high concentration thereof when there is water exists in the reaction system and thereby reduce the selectivity of target reaction products, the methylal may be fed in a distributed pattern, i.e. respectively feeding methylal at the first to fourth reactors according to certain ratios so as to inhibit side reactions which parallel to the main reaction series and consume methylal feedstock. At the same time, because a part of methylal is fed at the midstream and downstream of the reaction process, it is beneficial for more complete reaction of formaldehyde produced by depolymerization of polyformaldehyde in the system, thereby reducing the load of subsequent refinement units as well as feedstock loss. In order to adjust the distribution of target products with different methoxy group polymerization degrees, paraformaldehyde or trioxane may be fed in the distributed feeding pattern.

According to characteristics of heat effect of the reaction system and its intensity, the present invention also designs a corresponding suitable technical solution for heat exchange. Although the main reaction series has an above moderate heat effect as calculated according to the stoichiometric equation of the chemical reaction, however, in consideration of that the reaction rate is relatively low all over the variation range of the related operation conditions, the heat release intensity calculated according to a unit effective reactor volume during a unit period of time is not significant. Therefore, in consideration of heating when starting as well as normal steady state operation, a corresponding suitable technical solution for heat exchange is designed. Each reactor is provided with a jacket or coiled half-pipe outside a barrel thereof for serving as a heater when starting operation. For a reaction device with relatively large capacity, the first 2-4 reactors with larger heat effect are further provided with pipe bundles or coiled pipes arranged at the inside thereof for serving as coolers during normal operation. When starting operation, the heaters of each of the reactors are connected in parallel, and during normal operation, according to different operation modes, the cooling water in the coolers of different reactors may be connected in parallel and also may be connected in series and counter to the flow of the working fluid in the process. For example, when the reaction temperature needed in the reactor is successively decreased one by one in a stepwise manner, the cooling water may be connected in series and counter to the flow of the working fluid in the process, thereby reasonably distributing the heat transfer temperature difference between hot fluid and cold fluid of each reactor and thus reducing consumption of the cooling water.

The reaction device of the present invention can effectively achieve continuous production of polyoxymethylene dimethyl ethers, and both the distribution and the yield rate of the reaction products are better than those of prior art.

### BRIEF DESCRIPTION OF THE DRAWINGS

In order to make the contents of the present invention more easily understood clearly, further detailed description of the present invention is given below based on specific embodiments of the present invention and with reference of appended drawings. Wherein,

FIG. 1 is a reaction device as described in Embodiment 1;

FIG. 2 is a reaction device as described in Embodiment 2; and

FIG. 3 is a reaction device as described in Embodiments 4 and 5.

### DETAILED DESCRIPTION OF EMBODIMENTS

### Embodiment 1

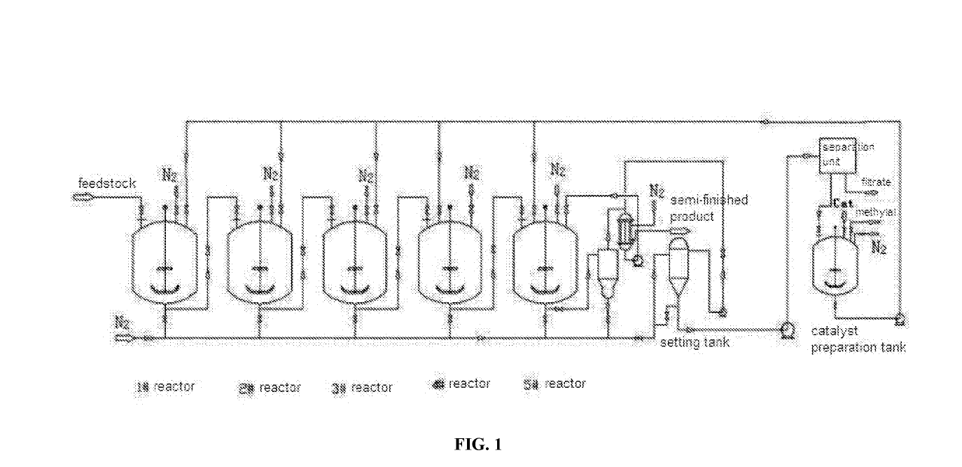

As shown in FIG. 1, an reaction device for catalytically synthesizing polyoxymethylene dimethyl ethers from paraformaldehyde powder and methylal as feedstock comprises 5 slurry bed stirred tank reactors connected in series. Each reactor has a volume of 0.5 m³ and a volume filling coefficient of 0.8. Each reactor is provided with a half-pipe heat exchanger wound around an outside of a barrel of the reactor for serving as a heater when starting operation as well as a cooler during normal operation. The first 2-4 reactors are provided with pipe bundles or coiled pipes arranged at the inside thereof for serving as coolers during normal operation. Each reactor has a heat exchange area of about 3 m³. Each of the tank reactors is provided with an axial-flow stirring paddle having 2-6 blades per layer, to ensure sufficient mixing of the reaction mixture.

An on-line solid-liquid separation device is provided after the last one of the tank reactors, to perform the separation of the reaction mixture from the catalyst. The catalyst obtained after sufficient solid-liquid separation is blended with a part of the methylal feedstock, and is then recycled into the first one of the tank reactors, so that continuous and steady operation of the reaction device is achieved.

Cation exchange resin is used as the catalyst, and the amount of the catalyst is equal to 2.0 wt % of the total amount of the feedstock. The molar ratio of paraformaldehyde, metered in mole number of formaldehyde contained therein, to methylal in the feedstock is 2. Each reactor has an operation temperature of 100° C., an operation pressure of 2.0 MPa kept by nitrogen gas, and a stirring speed of 90 r/min. By using water as coolant, the inlet temperature is controlled at 70° C., and the outlet temperature is controlled at about 90° C.

In the feedstock, paraformaldehyde has a mass flow rate of 185 kg/h, and methylal has a mass flow rate of 235 kg/h. The average residence time of the reaction mass in the reaction device is 4 hours. After a steady state is reached in continuous operation, the compositions of target products in the filtrate at the outlet of the reaction device are as listed in Table 1.

TABLE 1
distribution and yield rates of products

| DMMₙ/wt. % | | | | | | |
|---|---|---|---|---|---|---|
| n = 2 | n = 3 | n = 4 | n = 5 | n = 6 | n = 7 | ΣDMM₂₋₇/wt. % |
| 22.65 | 13.56 | 7.15 | 3.75 | 2.76 | 0.24 | 50.11 |

Thus it can be seen that, the reaction device of the present invention is able to effectively achieve continuous production of polyoxymethylene dimethyl ethers, and both the distribution and the yield rates of the reaction products can attain relatively high levels.

### Embodiment 2

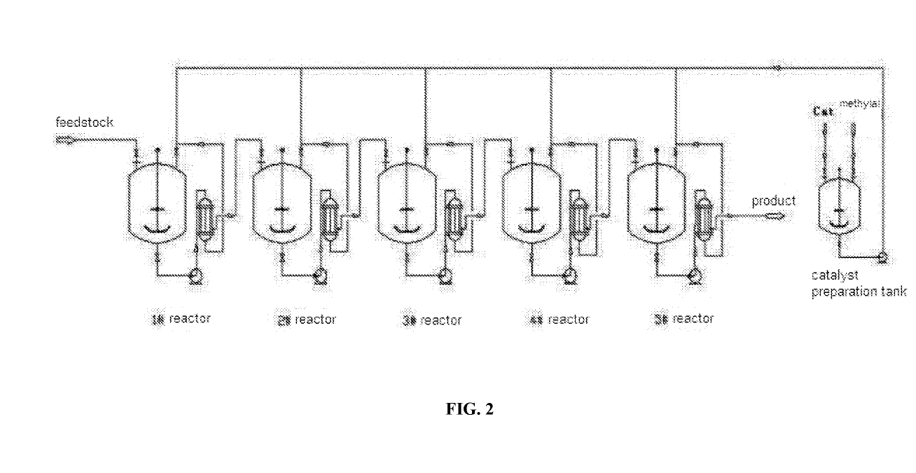

As shown in FIG. 2, an reaction device for catalytically synthesizing polyoxymethylene dimethyl ethers from sufficiently pre-depolymerized paraformaldehyde and methylal as feedstock comprises 7 slurry bed stirred tank reactors connected in series (only the connection apparatus of the first 5 reactors are shown). The configuration, geometric dimensions, operation pattern and entire reaction conditions of each of the reactors are the same as Embodiment 1. A difference in operation pressure between two adjacent ones of the tank reactors is utilized as a driving force of filtering, to achieve transport of the reaction mixture.

An on-line solid-liquid separation device is provided outside each of the reactors, to perform the separation of the reaction mixture from the catalyst. The on-line solid-liquid separation device is a multitubular filter performing on-line cross-flow filtering. A difference in operation pressure between two adjacent ones of the reactors is utilized as a driving force of filtering, to achieve solid-liquid separation as well as transport of the reaction mixture. The concentrated catalyst slurry obtained after separation is returned into the same reactor for continuous usage.

The average residence time of the reaction mixture in the reaction device is 5.6 hours. After a steady state is reached in continuous operation, the compositions of target products in the filtrate at the outlet of the reaction device are as listed in Table 2.

TABLE 2
distribution and yield rates of products

| DMMₙ/wt. % | | | | | | |
|---|---|---|---|---|---|---|
| n = 2 | n = 3 | n = 4 | n = 5 | n = 6 | n = 7 | ΣDMM₂₋₇/wt. % |
| 22.98 | 13.72 | 7.33 | 3.98 | 3.32 | 0.33 | 51.66 |

Thus it can be seen that, the reaction device of the present invention is able to effectively achieve continuous production of polyoxymethylene dimethyl ethers, and both the distribution and the yield rates of the reaction products can attain relatively high levels.

### Embodiment 3

The reaction device of this embodiment comprises 7 slurry bed stirred tank reactors which are numbered Reactor No. 1-7. Counting from the feed end, Reactors No. 1 and No. 2 are connected in series to form a Unit 1, Reactors No. 3 and No. 4 are connected in series to form a Unit 2, and the Unit 1 and Unit 2 are then connected in parallel to form a Unit 3 which is further connected in series with Reactors No. 5, No. 6 and No. 7. The reaction system and feedstock are the same as Embodiment 1, and the configuration and geometric dimensions of various reactors, operation pattern and operation conditions of each reactor are all the same as Embodiment 1.

The difference only lies in that, two halves of the total flow of feedstock is respectively fed into Reactor No. 1 and Reactor No. 3, and the mass streams flowing out of Reactor No. 2 and Reactor No. 4 are converged and then fed into Reactor No. 5 and then into Reactor No. 6 and then into Reactor No. 7 successively. After a steady state is reached in continuous operation, the compositions of target products in the filtrate at the outlet of the reaction device are as listed in Table 3.

TABLE 3
distribution and yield rates of products

| DMMₙ/wt. % | | | | | | |
|---|---|---|---|---|---|---|
| n = 2 | n = 3 | n = 4 | n = 5 | n = 6 | n = 7 | ΣDMM₂₋₇/wt. % |
| 23.55 | 13.71 | 7.50 | 4.12 | 3.91 | 0.48 | 53.27 |

As known from the aforementioned data of Embodiments 1-3, both the product distribution and the total yield rate do not have much difference between Embodiment 1 and Embodiment 2. Its fundamental reason, undoubtedly, lies in that the main reaction series of the related reaction system is a group of reversible exothermic reactions, so that, with predetermined feedstock compositions and a predetermined reaction temperature, as the reactions go on, the system is increasingly approaching equilibrium, and thus the reaction driving forces and the corresponding reaction rates are becoming less. Therefore, although the device can achieve continuous operation of the entire reaction, it has very little effect to meaninglessly increase reactor sums and corresponding reaction time under this type of conditions.

As can be seen by comparison of data listed in Embodiment 2 and Embodiment 3, both the product distribution and the total yield rate of Embodiment 3 are observed to be improved than Embodiment 2. As for its reason, it is considered that, in Embodiment 3, because only a half of the feedstock load is introduced into each mass stream of the Unit 1 and Unit 2 composed of Reactors No. 1 and No. 2 connected in series and Reactors No. 3 and No. 4 connected in series respectively, the average residence time of each one of these two reaction streams is 3.2 hours, which is the initial first 3.2 hours of the reaction starting from the feedstock concentrations. Under the same operation temperature, pressure and feedstock molar ratio, the system is relatively far from its equilibrium point and has a relatively high reaction rates in the first 3 hours of reaction, thus almost 80% of the reaction task can be carried out. In other words, the first 4 reactors among the 7 reactors used in Embodiment 3 are operated at relatively high efficiency. Thus it can be seen that, the reaction device of Embodiment 3 has a connection pattern which is more beneficial for the entire reaction to be carried out in a high efficient and continuous manner.

### Embodiment 4

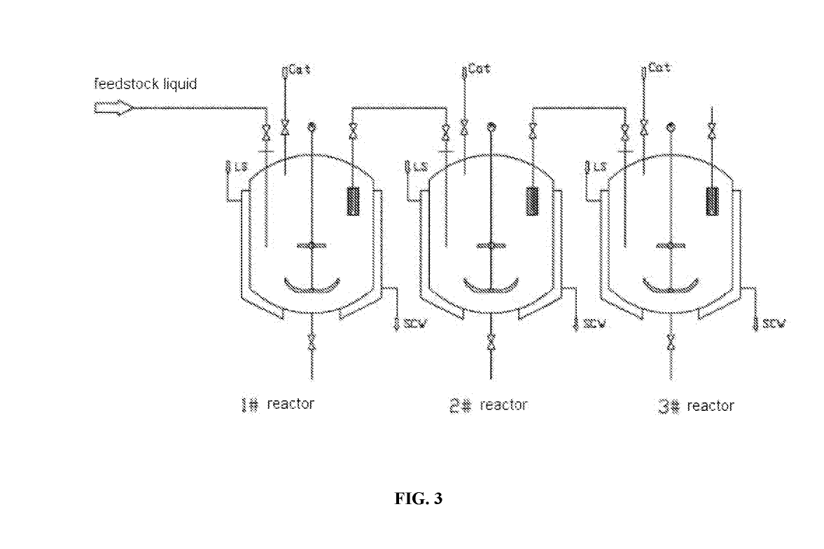

As shown in FIG. 3, feedstock solution is prepared according to a 2:1 molar ratio of paraformaldehyde, metered in mole number of formaldehyde contained therein, to methylal, and is fed into a combination of 3 slurry bed tank reactors connected in series with each tank reactor having a volume of 5.0 L. The temperatures of the first, second and third reactors are respectively controlled at 100° C., 80° C. and 60° C., feedstock is supplied continuously and its average residence time in each tank reactor is kept at about 2 hours. The type and added amount of catalyst as well as other reaction conditions are the same as Embodiment 1.

Each of the reactors is provided with a jacket or coiled half-pipe outside the barrel of the reactor for serving as a heater when starting operation as well as a cooler during normal operation. Inside the three reactors, pipe bundles or coiled pipes are provided as coolers during normal operation. An interlock control system is provided at the bottom of each of the reactors for controlling the initial fluidization of the catalyst before starting of the stirring paddle, to ensure operation safety when the added amount of the catalyst is relatively large.

An on-line solid-liquid separation device is provided inside each of the reactors, to perform the separation of the reaction mixture from the catalyst. The on-line solid-liquid separation device is composed of powder metallurgy filtering elements which are divided into two groups, with one group for filtering and the other group for purging, and with alternation switching, so that the catalyst is retained within the reactor for continuous usage. A difference in operation pressure between two adjacent ones of the tank reactors is utilized as a driving force of filtering, to achieve solid-liquid separation as well as transport of the reaction mixture.

After a steady state is reached in continuous operation, samples are taken to perform composition analysis. The final total yield of target products ΣDMM₂₋₈=57.22 wt %, with DMM₈ detected in the final product.

### Embodiment 5

As shown in FIG. 3, the reaction device of this embodiment is the same as Embodiment 4.

Feedstock solution is prepared according to a 2:1 molar ratio of paraformaldehyde, metered in mole number of formaldehyde contained therein, to methylal, and is fed into a combination of 3 slurry bed tank reactors connected in series with each tank reactor having a volume of 5.0 L. The temperatures of the three reactors are equally controlled at 100° C., feedstock is supplied continuously and its average reaction time in each tank reactor is kept at about 2 hours until a steady state is reached. The type and added ratio of catalyst as well as other reaction conditions are the same as Embodiment 4. After a steady state is reached in continuous operation, samples are taken to perform composition analysis. The final total yield of target products ΣDMM₂₋₈=53.27 wt %, with DMM₈ detected in the final product.

TABLE 4
Concentration distribution of products

| No. | DMM₂ | DMM₃ | DMM₄ | DMM₅₋₈ | DMM_{n>8} |
|---|---|---|---|---|---|
| Embodiment 4 | 25.02 | 14.54 | 8.43 wt % | 9.23 wt % | ~0 |
| | wt % | wt % | | | |
| Embodiment 5 | 23.55 | 13.71 | 7.50 wt % | 8.51 wt % | ~0 |
| | wt % | wt % | | | |

As can be seen from analysis of data listed in Table 4, with respect to the combination of continuously operated three slurry bed tank reactors connected in series, by comparing Embodiment 4 wherein the three reactors are controlled at temperatures decreasing successively one by one in a stepwise manner with Embodiment 5 wherein the three reactors are controlled at a same temperature of 100° C., it can be found that, after 6 hours of reaction in both Embodiments 4 and 5, the concentrations of each target product of the former is higher than that of the latter, with the total yield ΣDMM₂₋₈ increased by about 4 percent as well as a higher percentage of DMM₅₋₈ in the target product total amount. All these clearly indicate that, for a combination of continuously operated multiple tank reactors connected in series, the reaction process carried out at successive stepwise decreased temperatures provided by the present invention according to the principle of reaction system thermodynamic equilibrium is effective, and it indeed drives the chemical equilibrium of the reaction system to move towards the direction of producing target products, which not only increases the once-through total yield of target products, but also increases the selectivity of target products with higher polymerization degrees, thereby intensifying the synthesis reaction.

Apparently, the aforementioned embodiments are merely examples illustrated for clearly describing the difference in operation performance when using different schemes, rather than limiting the implementation ways thereof. For those skilled in the art, various changes and modifications in other different forms can be made on the basis of the aforementioned description. It is unnecessary and impossible to exhaustively list all the implementation ways herein. However, any obvious changes or modifications derived from the aforementioned description are intended to be embraced within the protection scope of the present invention.

1. A continuous reaction device for synthesizing polyoxymethylene dimethyl ethers, the reaction using paraformaldehyde and methylal as feedstock or using trioxane and methylal as feedstock and being carried out in the presence of an acidic catalyst, wherein,
the continuous reaction device comprises multiple reactors connected in series or in combination of series connection and parallel connection, and also comprises an on-line solid-liquid separation device to perform solid-liquid separation of the reaction mixture from the catalyst;
each of the tank reactors is independently controlled at a pressure of 1.0-4.0 MPa and a temperature of 50-120° C.; a molar ratio of paraformaldehyde or trioxane, metered in mole number of formaldehyde contained therein, to methylal in the feedstock is 0.5-5.0; and
the amount of the catalyst is equal to 1.0-4.0 wt % of the total amount of the feedstock;
each of the tank reactors is provided with an axial-flow stirring paddle having 2-6 blades per layer, to ensure sufficient mixing of the reactants and catalyst.

2. The continuous reaction device in accordance with claim 1, wherein, when paraformaldehyde powder and methylal are used as feedstock, the on-line solid-liquid separation device is arranged after the last one of the tank reactors, to perform the separation of the reaction mixture from the catalyst slurry; and a recycling pipeline is provided to recycle the catalyst, obtained after sufficient solid-liquid separation and blended with a part of the methylal, into the first one of the tank reactors, so that continuous and steady operation of the reaction device is achieved.

3. The continuous reaction device in accordance with claim 1, wherein, when sufficiently pre-depolymerized paraformaldehyde and methylal are used as feedstock or trioxane and methylal are used as feedstock, each of the tank reactors is provided with an on-line solid-liquid separation device arranged at the inside or outside thereof, to perform the separation of the reaction mixture from the catalyst.

4. The continuous reaction device in accordance with claim 3, wherein, the on-line solid-liquid separation device arranged at the inside of each of the tank reactors is composed of powder metallurgy filtering elements which is divided into two groups, with one group for filtering and the other group for purging, and with alternation switching performed automatically, so that the catalyst is retained within the tank reactor.

5. The continuous reaction device in accordance with claim 3, wherein, the on-line solid-liquid separation device arranged at the outside of each of the tank reactors is a multitubular filter performing on-line cross-flow filtering, so that the catalyst thick slurry is recycled back into the same one of the tank reactors for continuous use.

6. The continuous reaction device in accordance with claim 1, wherein, a difference in operation pressure between two adjacent ones of the tank reactors is utilized as a driving force of filtering, to achieve solid-liquid filtering separation as well as transport of the reaction mixture from one reactor to the next.

7. The continuous reaction device in accordance with claim 1, wherein, each of the tank reactors is provided with a jacket or coiled half-pipe arranged outside a barrel of the reactor for serving as a heater when starting operation, and each of the reactors is provided with an internal heat exchanger arranged at the inside thereof for serving as a cooler during normal operation.

8. The continuous reaction device in accordance with claim 1, wherein, an interlock control system is provided at the bottom of each of the tank reactors for controlling the initial fluidization of the catalyst and the starting of the stirring paddle, to ensure operation safety when the added amount of the catalyst is relatively large.

9. The continuous reaction device in accordance with claim 1, wherein, the tank reactors are slurry bed stirred tank reactors, and the reaction device includes 2-8 reactors.

10. The continuous reaction device in accordance with claim 9, wherein, the operation temperature of the tank reactors decreases successively by 5-20° C. per reactor; or the entire reaction is controlled by feeding all the feedstock at the first one of the reactors or by distributed feedstock feeding.

11. The continuous reaction device in accordance with claim 2, wherein, a difference in operation pressure between two adjacent ones of the tank reactors is utilized as a driving force of filtering, to achieve solid-liquid filtering separation as well as transport of the reaction mixture from one reactor to the next.

12. The continuous reaction device in accordance with claim 3, wherein, a difference in operation pressure between two adjacent ones of the tank reactors is utilized as a driving force of filtering, to achieve solid-liquid filtering separation as well as transport of the reaction mixture from one reactor to the next.

13. The continuous reaction device in accordance with claim 2, wherein, each of the tank reactors is provided with a jacket or coiled half-pipe arranged outside a barrel of the reactor for serving as a heater when starting operation, and each of the reactors is provided with an internal heat exchanger arranged at the inside thereof for serving as a cooler during normal operation.

14. The continuous reaction device in accordance with claim 3, wherein, each of the tank reactors is provided with a jacket or coiled half-pipe arranged outside a barrel of the reactor for serving as a heater when starting operation, and each of the reactors is provided with an internal heat exchanger arranged at the inside thereof for serving as a cooler during normal operation.

15. The continuous reaction device in accordance with claim 2, wherein, an interlock control system is provided at the bottom of each of the tank reactors for controlling the initial fluidization of the catalyst and the starting of the stirring paddle, to ensure operation safety when the added amount of the catalyst is relatively large.

16. The continuous reaction device in accordance with claim 3, wherein, an interlock control system is provided at the bottom of each of the tank reactors for controlling the initial fluidization of the catalyst and the starting of the stirring paddle, to ensure operation safety when the added amount of the catalyst is relatively large.

17. The continuous reaction device in accordance with claim 2, wherein, the tank reactors are slurry bed stirred tank reactors, and the reaction device includes 2-8 reactors.

18. The continuous reaction device in accordance with claim 17, wherein, the operation temperature of the tank reactors decreases successively by 5-20° C. per reactor; or the entire reaction is controlled by feeding all the feedstock at the first one of the reactors or by distributed feedstock feeding.

19. The continuous reaction device in accordance with claim 3, wherein, the tank reactors are slurry bed stirred tank reactors, and the reaction device includes 2-8 reactors.

20. The continuous reaction device in accordance with claim 19, wherein, the operation temperature of the tank reactors decreases successively by 5-20° C. per reactor; or the entire reaction is controlled by feeding all the feedstock at the first one of the reactors or by distributed feedstock feeding.
